(19) United States
(12) Patent Application Publication
(10) Pub. No.: US 2018/0341917 A1
(43) Pub. Date: Nov. 29, 2018

(54) SYSTEM AND METHOD FOR MANAGING A NETWORK CONNECTED APPLIANCE

(71) Applicant: Mastercard International Incorporated, Purchase, NY (US)

(72) Inventors: Gurpreet Atwal, Chesterfield, MO (US); Jaipal Singh Kumawat, Rajasthan (IN); Hemant Arora, Haryana (IN)

(21) Appl. No.: 15/976,339

(22) Filed: May 10, 2018

(30) Foreign Application Priority Data
May 26, 2017 (SG) 10201704333R

(51) Int. Cl. G06Q 10/08; G06Q 20/12; G06Q 30/06; G06Q 30/02

(52) U.S. Cl. CPC G06Q 10/0875; G06Q 30/0222; G06Q 30/0633; G06Q 20/12

(57) ABSTRACT

A method for managing a network connected appliance, the method including, in one or more electronic processing devices: (a) determining status information associated with the appliance; (b) determining a goods/service requirement for the appliance in accordance with the status information; and, (c) causing the required goods/service to be purchased from a merchant via a payment system.

### CROSS-REFERENCE TO RELATED APPLICATION

This application is a U.S. National Stage filing under 35 U.S.C. § 119, based on and claiming benefits of and priority to Singapore Patent Application No. 10201704333R filed on May 26, 2017. The entire disclosure of the above application is incorporated herein by reference.

### BACKGROUND OF THE INVENTION

The present invention relates to a system and method for managing a network connected appliance, and in one example, to a system and method for managing supply, service and control of a home appliance.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

In recent years, substantial advances have been made in the incorporation of network connectivity in devices. Consequently, the number of network connected devices is increasing significantly, and many households now have smart appliances including televisions, refrigerators, washing machines, air conditioners, cooking appliances and the like.

Whilst in the past it has been possible to remotely control the operation of some aspects of these appliances via a smartphone or the like, users have not been provided with any other ability to manage their appliances on-the-go. For example, users have not been provided with the ability to remotely manage the supply of consumable items of their appliances or the servicing of the appliances in the event that the appliance is malfunctioning or requires service or repair. Often the first time a user notices that a consumable item has run out and needs ordering is when they go to use the appliance or consume the item. The user then has to go to a shopping centre, grocer or the like and purchase the required items, a task which is often inconvenient and hindered by retail opening hours.

It is against this background, and the problems and difficulties associated therewith, that the present invention has been developed.

### SUMMARY OF THE PRESENT INVENTION

In one broad form, there is provided a system for managing one or more network connected appliances, the system including one or more electronic processing devices that:
a) receive an alert notification generated by the one or more appliances, the alert notification including status information indicative of at least one of:
   i) a determined service condition of an appliance; and,
   ii) a determined quantity of available goods associated with the appliance;
b) determine a goods/service requirement for the appliance in accordance with the status information;
c) generate a representation of the goods/service requirement;
d) cause the representation of the goods/service requirement to be displayed to a user on a user device;
e) determine one or more merchant offers in accordance with the required goods/service;
f) cause the one or more merchant offers to be displayed to the user; and,
g) in response to user input:
   i) determine a user selected merchant offer;
   ii) cause an order to be placed with the selected merchant for the required goods/service; and,
   iii) cause payment for the required goods/service to be processed with the selected merchant via a payment system.

In another broad form, there is also provided a method for managing one or more network connected appliances, the method including, in one or more electronic processing devices:
a) receiving an alert notification generated by the one or more appliances, the alert notification including status information indicative of at least one of:
   i) a determined service condition of an appliance; and,
   ii) a determined quantity of available goods associated with the appliance;
b) determining a goods/service requirement for the appliance in accordance with the status information;
c) generating a representation of the goods/service requirement;
d) causing the representation of the goods/service requirement to be displayed to a user on a user device;
e) determining one or more merchant offers in accordance with the required goods/service;
f) causing the one or more merchant offers to be displayed to the user; and,
g) in response to user input:
   i) determining a user selected merchant offer;
   ii) causing an order to be placed with the selected merchant for the required goods/service; and,
   iii) causing payment for the required goods/service to be processed with the selected merchant via a payment system.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

A non-limiting example of the present invention will now be described with reference to the accompanying drawings, in which: —

FIG. 1 is a flow chart of an example of a method for managing a network connected appliance;

FIG. 2 is a schematic diagram of an example of a system for managing a network connected appliance;

FIG. 3 is a schematic diagram of an example of a network connected appliance;

FIG. 4 is a schematic diagram of an example of a payment system;

FIG. 5 is a schematic diagram of an example of a user device;

FIG. 6 is a schematic diagram of an example of a merchant server;

FIG. 7 is a flowchart of an example of a specific process of purchasing goods for an appliance through an application executing on the user device;

FIG. 8 is a flowchart of a further example of a specific process of purchasing goods for an appliance through an application executing on the user device; and,

FIG. 9 is a flowchart of an example of a process of booking a service for the appliance with a preferred servicing agency.

### DETAILED DESCRIPTION OF THE PREFERRED EMBODIMENTS

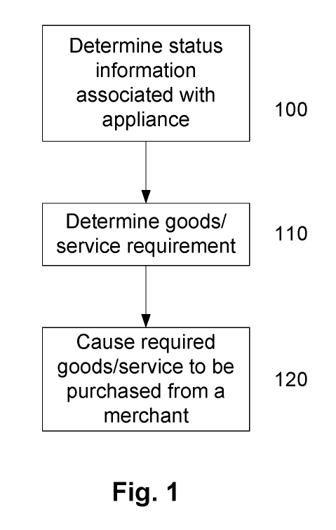

An example of a method for managing a network connected appliance shall now be described with reference to FIG. 1.

For the purpose of illustration, it is assumed that the method is performed at least in part using one or more electronic processing devices such as a suitably programmed microcontroller forming part of a user device, such as mobile phones, portable computers, tablet computers, or the like. The user device is in communication with one or more appliances, such as televisions, refrigerators, washing machines, air conditioners, cooking appliances and the like via a communications network. The user device is also typically in communication with a merchant processing system and/or database and a payment system which may comprise any suitable computer system such as a server that is capable of processing payments made by the user and which may include a number of processing devices associated with each of an issuer, acquirer, card network and payment gateway, or alternatively, the payment processing system may include any one or more of these entities and this will be discussed further below.

A “network connected appliance” in the context of this disclosure may represent any type of appliance having network connectivity to enable it to communicate wirelessly to one or more user devices as mentioned above. Whilst typically the appliance will be a smart home appliance, the term “network connected appliance” is to be understood to include any type of machine or device such as automobile that is capable of connecting to a network.

In this example, at step 100, the one or more electronic processing devices determine status information associated with the appliance. The status information may provide an indication of a service condition of the appliance (i.e. is it operating to a rated performance level or is it malfunctioning). Alternatively, the status information may provide an indication of a quantity or amount of consumable items or goods available or remaining for use. For example, for a washing machine, the status information may be indicative of how much laundry detergent is left and for a refrigerator, the status information may be indicative of a quantity or amount of available groceries or other food or drink items stored in the refrigerator.

Typically, the appliance will have one or more sensors used to detect the amount or quantity of goods available. For example, load sensors or strain gauges may be used to detect the weight of an item, for example a carton of milk or tub of yoghurt in order to determine the amount of the goods remaining. Alternatively, sensors could be used to detect the presence of an item so that the appliance can detect when the item has been consumed and taken from the appliance. Any suitable type of sensor may be used such as a proximity sensor, IR sensor or image sensors such as digital cameras or camera modules. In one example, the sensors on-board the appliance detect the quantity or amount of available goods and provide this information to an appliance processing system such as a suitably programmed microcontroller. The appliance then sends the status information to the user device, such as a smart phone, which interprets the status information via a suitably programmed application executing on the user device.

At step 110, the one or more electronic processing devices determine a goods/service requirement for the appliance in accordance with the status information. In one example, the goods/service requirement is determined by comparing the status information with a threshold such as a lower limit for the amount or quantity of goods available which may be pre-configured by the user in accordance with their requirements/consumption. For example, a user may consume 2 L of milk in 3 days and accordingly may define a lower limit of 500 mL as the amount remaining before another carton of milk is to be purchased. In another example, a user may place a dozen eggs in an egg tray of a refrigerator and define a lower limit of 4 eggs remaining before another dozen eggs are required to be purchased.

After the one or more electronic processing devices determine a goods/service requirement, at step 120 the one or more electronic processing devices cause the required goods/service to be purchased from a merchant via a payment system. Typically, the user is presented with an offer from a merchant who sells the required goods/service. The user is able to order the required goods/service from the merchant and pay for the goods/service through the application executing on the user device. In one example, the user may have a digital or mobile wallet account linked to the application so that payments can be processed automatically at checkout. Alternatively, the user may be required to manually input account or card details to enable the transaction with the merchant to be processed through the application. Whilst typically, the goods/service are ordered and payment processed through the application on the user device, in an alternative example, the appliance processing system may be configured to order the required goods/service and process the payment. In such an example, the user may order the required goods/service through the application on the user device which is responsive to send an order signal to the appliance which then actually processes the order and payment to the merchant.

Accordingly, the above described method provides a number of advantages.

A single platform is provided for users to remotely (on-the-go) manage all of their home appliances in terms of supply of consumable goods and servicing. This level of management ability may further be integrated with control of the appliances as well. The ability to manage the supply of goods and servicing of the appliances has time saving and efficiency benefits as goods may be ordered before they run out to ensure that supply is always at optimal levels. Consumers will also need to go to the shops less frequently as goods can be purchased on-line and delivered to their house or made available for pick-up. This also means that goods can be purchased from anywhere that there is mobile connectivity. The ability to pre-emptively book servicing will ensure that down-time of appliances is minimised and that they are operating at rated performance levels of efficiency etc.

The platform also provides benefits for merchants who can make offers available to users of the platform. Merchants can advertise their offers which may be displayed to the users based on the list of required goods/service.

A number of further features will now be described.

As previously described, the status information is indicative of one or more parameters associated with the appliance including at least one of: a quantity or amount of available goods, and a service condition. The one or more parameters are monitored by the appliance using one or more sensors integrated with the appliance. The status information is derived from sensor readings which are typically processed by a microcontroller or the like of the appliance before being sent to the user device.

Typically, the one or more electronic processing devices form part of the user device, the user device executing an application that receives the status information from the appliance and initiates a payment process with the merchant via the payment system. In this way, the application provides a convenient way for the user to be able to manage their appliances and facilitate payment for goods/service.

The user device receives the status information from the appliance via a communications network. The communications network typically uses a wireless communication protocol including one of Bluetooth™ Low Energy (BLE), ZigBee, WiFi or NFC. The status information may also be sent to the user device over a cellular network so there is no requirement for the user to be within a certain distance of the appliance to receive the communication.

The appliance may be programmed to send the status information to the user device in a number of ways. In one example, the appliance sends the status information periodically or alternatively in response to a user request, for example when the user wants to know how much of a particular item is available. Typically however, the status information is provided in the form of an alert notification in response to a determined service condition or quantity of available goods.

In this regard, the alert information is generated by the appliance and sent to the user device if either a determined quantity of available goods is below a user configured lower limit of available goods remaining or if a determined service condition is indicative of one of: an appliance malfunction, or, a component of the appliance being below a performance threshold. The lower or minimum limits of goods available are configurable and typically set by a user in accordance with their requirements or consumption habits.

Typically, the user device is responsive to receiving the alert notification to generate a representation of the required goods/service, cause the representation of the required goods/service to be displayed to a user and prompt the user to purchase the required goods/service. The representation may be in the form of a list of items which the user can review. The representation may also include an icon or image of the goods and a prompt in the form a touch symbol or icon and the like enabling a user to ‘Buy Now’ or ‘View offers’.

As previously mentioned, merchants are able to use the platform to offer goods/services to users. As such, the method typically further includes, in the one or more electronic processing devices, determining one or more merchant offers in accordance with the required goods/service. The merchant offers may be retrieved from a merchant database or merchant server where available offers are stored. Alternatively, the merchant offers may be stored on an application server and updated periodically by the merchant. A representation of the one or more merchant offers is then generated and causes to be displayed to the user. The merchant offers may be displayed in response to a user selecting a particular item from a list of required goods/service provided in the alert notification. The application may then receive user input commands indicative of a selected merchant offer to initiate a transaction with the merchant.

In this regard, selecting the merchant offer causes an order to be placed with the selected merchant for the required goods/service, and payment for the required goods/service to be processed with the merchant via the payment system. The one or more electronic processing devices typically send an order request to the merchant who dispatches the order once confirmation of payment is received. As previously mentioned, the user may have a digital wallet linked to the application software to facilitate payment for goods/service without needing to manually provide bank account or credit card details each time a transaction is processed.

Once a preferred merchant offer is selected, the payment process may proceed in a conventional manner. In one example, the application sends the user account information (for example obtained through digital wallet) and payment information to the merchant's acquirer. The acquirer then requests that the card network obtain an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account. After payment is received, the merchant then proceeds to facilitate dispatch of the ordered goods.

Typically, the method further includes generating a representation of a flag indicative of an order having been placed for the required goods/service and causing the flag to be displayed on the user device. The flag may be an icon that states ‘Order placed’ or a symbol indicative of such which appears next to the particular item. The user may also received a notification advising that the order has been successfully placed. In one example, the flag may also be caused to be displayed on the appliance, for example proximate the position of the goods.

The use of such a flag is particularly useful for other users in a household for example that may also use the platform to manage supply, servicing or control of the appliances to prevent the same order being placed more than once. In one example, the method further includes generating a notification that an order for the required goods/service has been placed, and causing the notification to be sent to a user device of one or more further users of the appliance.

If the alert notification is generated because a determined service condition is indicative of an appliance malfunction, or a component of the appliance being below a performance threshold, the method may further include causing a service to be booked automatically. For example, the user device may be responsive to receiving the alert notification to determine a preferred service agency to carry out the required service; and, automatically cause an order to be placed with the preferred service agency for the required service, and payment for the required service to be processed with the preferred service agency via the payment system. In this regard, the user can configure preferred servicing agencies in the application for the appliance which are automatically booked when a service for the appliance is deemed to be needed.

As previously mentioned, users may also be able to control appliances remotely on-the-go. For example, lights be switched on, air-conditioners may be activated prior to the user arriving home, washing machine modes may be changed, ovens may be turned on etc. Typically, therefore the method further includes in the one or more electronic processing devices, receiving user input indicative of a desired control command for the appliance, generating a control signal in accordance with the desired control command; and causing the control signal to be sent to the appliance to effect remote control of the appliance.

In a broad form, there is provided a system for managing a network connected appliance, the system including one or more electronic processing devices that determine status information associated with the appliance, determine a goods/service requirement for the appliance in accordance with the status information, and cause the required goods/service to be purchased from a merchant via a payment system.

In yet a further broad form, there is provided a system for managing one or more network connected appliances, the system including one or more electronic processing devices that receive an alert notification generated by the one or more appliances, the alert notification including status information indicative of at least one of a determined service condition of an appliance, and a determined quantity of available goods associated with the appliance. The processing devices further determine a goods/service requirement for the appliance in accordance with the status information, generate a representation of the required goods/service, cause the representation of the required goods/service to be displayed to a user on a user device, determine one or more merchant offers in accordance with the required goods/service, cause the one or more merchant offers to be displayed to the user. In response to user input, the system then determines a user selected merchant offer, causes an order to be placed with the selected merchant for the required goods/service, and causes payment for the required goods/service to be processed with the selected merchant via a payment system.

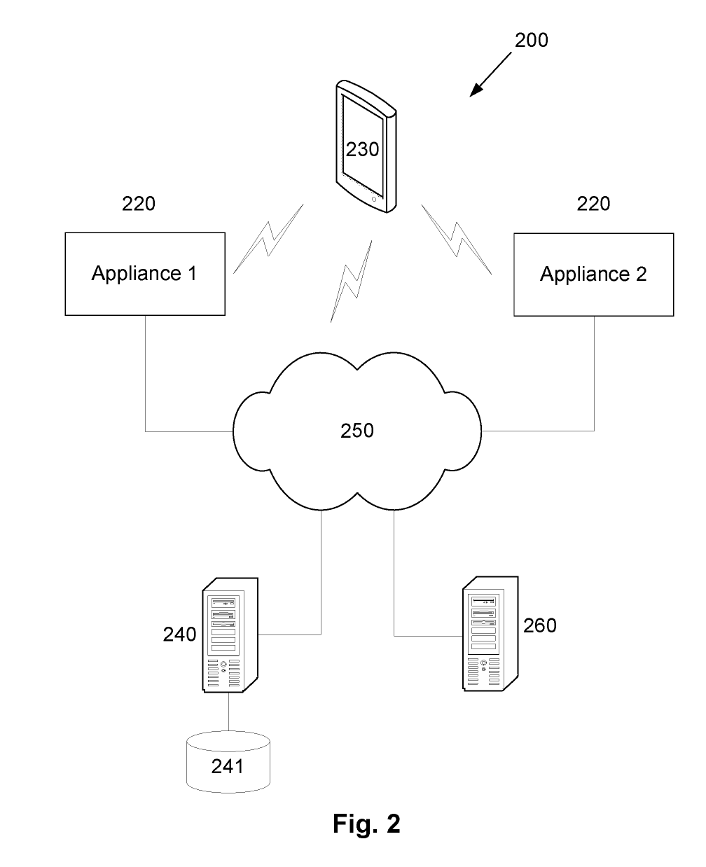

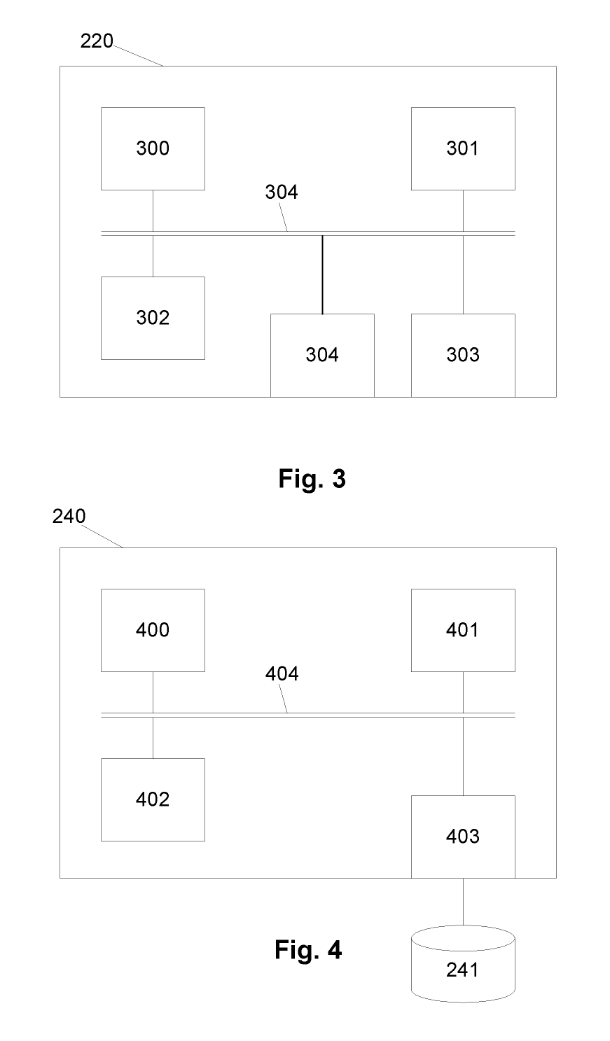

In one example, the process is performed by one or more processing systems operating as part of a distributed architecture, an example of which will now be described with reference to FIG. 2.

In this example, the system 200 includes a plurality of network connected appliances 220 in communication with a user device 230. The user device 230 is in communication with a payment system 240, and a server 260 of a goods/service provider (i.e. merchant) via a communications network 250. The payment system 240 may be in communication with a database 241. The plurality of network connected appliances 220 are also in communication with the communications network 250.

The communications network 250 can be of any appropriate form, such as the Internet and/or a number of local area networks (LANs). It will be appreciated that the configuration shown in FIG. 2 is for the purpose of example only, and in practice the user device 230, network connected appliances 220, server 260 and payment system 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the user device 230 communicates with the network connected appliances 220 via a wireless communication protocol such as Bluetooth, Wi-Fi, Zigbee, or through Near Field Communication (NFC) but not limited to such.

The merchant server 260 may include any suitable processing device, such as a computer system, server(s), personal computer, or the like. Similarly, the payment processing device(s) 240 may also include any suitable processing device such as computer system(s), server(s), and/or may be composed of a number of different processing systems for example related to an acquirer, issuer, card network, and payment gateway.

The client device 230 typically includes a mobile device, such as a tablet or smartphone, however may also include any suitable processing system, and this will also be described in more detail below.

### Network Connected Appliance 220

A suitable network connected appliance 220 for use in the system 200 shall now be described. The appliance 220 may include any electrical device or machine with network connectivity including common household appliances such as refrigerators, televisions, air conditioners, ovens, microwaves, dishwashers, washing machines etc. Alternatively, the appliance may be a machine like an automobile, motor cycle, etc. having network connectivity.

In this example, the network connected appliance 220 includes at least one microprocessor 300, a memory 301, an optional input/output device 302, such as a display, keyboard, touchscreen and the like, and an external interface 303, interconnected via a bus 304 as shown. In this example the external interface 303 can be utilised by the network connected appliance 220 when communicating with peripheral devices, such as the user devices 230, communications networks, databases, other storage devices, or the like. Although only a single interface 303 is shown, this is for the purpose of example only, and in practice multiple interfaces using various methods (e.g. Ethernet, serial, USB, wireless, Bluetooth™ Low Energy (BLE), Near Field Communication (NFC), or the like) may be provided. The appliance 220 further includes one or more sensors 304 in communication with the processor 300 for monitoring the status information such as the condition of the appliance and amount or quantity of available goods.

In use, the microprocessor 300 executes instructions in the form of applications software stored in the memory 301 to allow communication with the user device 230, for example to receive a request for status information from the user device 230 and send an alert notification to the user device 230. The applications software may include one or more software modules, and may be executed in a suitable execution environment, such as an operating system environment, or the like.

Accordingly, it will be appreciated that the network connected appliance 220 may include any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the processing system is a standard processing system such as an Intel Architecture based processing system, which executes software applications stored on non-volatile (e.g., hard disk) storage, although this is not essential.

### Payment System 240

A suitable payment system 240 for use in the system 200 described in any one of the above examples is shown in FIG. 4.

In this example, the payment system 240 is a server that includes at least one microprocessor 400, a memory 401, an optional input/output device 402, such as a display, keyboard, touchscreen and the like, and an external interface 403, interconnected via a bus 404 as shown. In this example the external interface 403 can be utilised for connecting the payment server 410 to peripheral devices, such as user device 230, the communication networks 250, databases 241, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to allow communication with the user device 230, for example to provide payment options. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the processing system 400 is a standard processing system such as an Intel Architecture based processing system, which executes software applications stored on non-volatile (e.g., hard disk) storage, although this is not essential.

In other examples, such as described above, the payment system is formed of multiple computer systems interacting, for example, via a distributed network arrangement. As distributed networking is known in the art, it will not be described further in more detail.

In particular, the payment system may include or be in communication with a number of processing systems associated with each of an issuer, acquirer, card network and payment gateway, or alternatively, the payment system may be any one or more of these entities.

In one example as will be well understood in the art, the payment system sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

### User Device 230

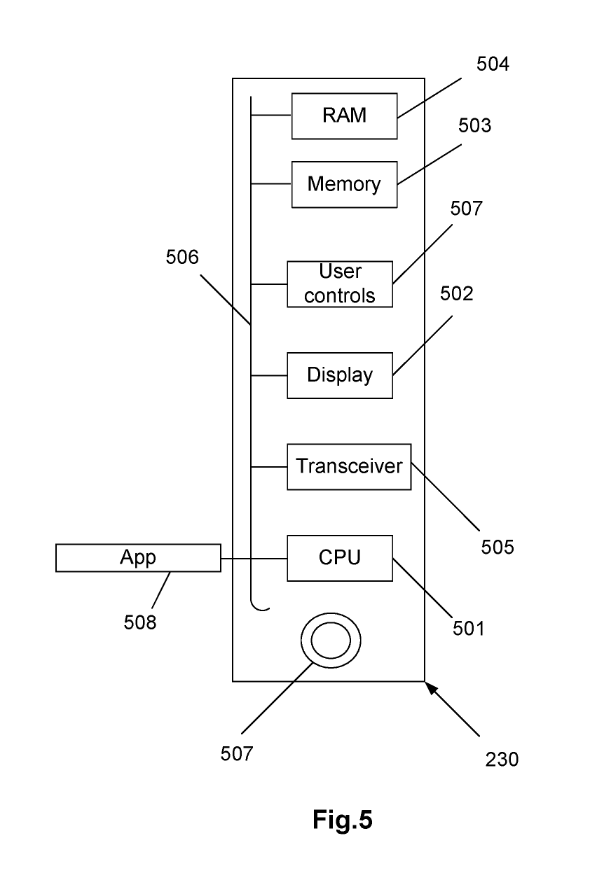

The user device 230 of any of the examples herein may be a handheld computer device such as a smart phone or a PDA such as one manufactured by Apple™, LG™, HTC™, Blackberry™, or Motorola™. The user device 230 may include a mobile computer such as a tablet computer. An exemplary embodiment of a user device 230 is shown in FIG. 5. As shown, the device 230 includes the following components in electronic communication via a bus 506:
1. a display 502;
2. non-volatile memory 503;
3. random access memory (“RAM”) 504;
4. N processing components 501;
5. a transceiver component 505 that includes N transceivers; and
6. user controls 507.

Although the components depicted in FIG. 5 represent physical components, FIG. 5 is not intended to be a hardware diagram; thus many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

The display 502 generally operates to provide a presentation of content to a user, and may be realized by any of a variety of displays (e.g., CRT, LCD, HDMI, micro-projector and OLED displays). And in general, the non-volatile memory 503 functions to store (e.g., persistently store) data and executable code including code that is associated with the functional components of a browser component and applications, and in one example, a payment application 508 executing on the user device 230. In some embodiments, for example, the non-volatile memory 503 includes bootloader code, modem software, operating system code, file system code, and code to facilitate the implementation of one or more portions of the payment application 508 as well as other components well known to those of ordinary skill in the art that are not depicted for simplicity.

In many implementations, the non-volatile memory 503 is realized by flash memory (e.g., NAND or ONENAND memory), but it is certainly contemplated that other memory types may be utilized as well. Although it may be possible to execute the code from the non-volatile memory 303, the executable code in the non-volatile memory 503 is typically loaded into RAM 304 and executed by one or more of the N processing components 501.

The N processing components 501 in connection with RAM 504 generally operate to execute the instructions stored in non-volatile memory 503 to effectuate the functional components. As one of ordinarily skill in the art will appreciate, the N processing components 501 may include a video processor, modem processor, DSP, graphics processing unit (GPU), and other processing components.

The transceiver component 505 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

### Merchant Server 260

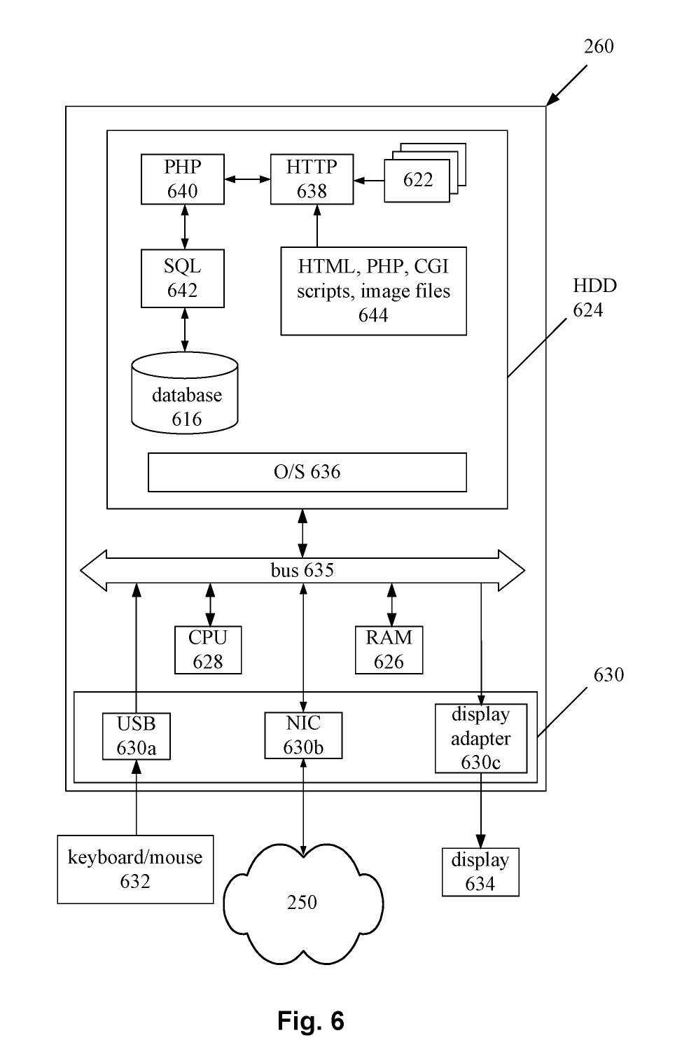

An example of the server 260 is as shown in FIG. 6. As described in a preceding section, the server 260 is able to communicate with other components of the system 200 over the wireless communications network 250 using standard communication protocols.

The components of the server 260 can be configured in a variety of ways. The components can be implemented entirely by software to be executed on standard computer server hardware, which may comprise one hardware unit or different computer hardware units distributed over various locations, some of which may require the communications network 250 for communication. A number of the components or parts thereof may also be implemented by application specific integrated circuits (ASICs) or field programmable gate arrays.

In the example shown in FIG. 6, the server 260 is a commercially available server computer system based on a 32 bit or a 64 bit Intel architecture, and the processes and/or methods executed or performed by the server 260 are implemented in the form of programming instructions of one or more software components or modules 622 stored on non-volatile (e.g., hard disk) computer-readable storage 624 associated with the server 260. At least parts of the software modules 622 could alternatively be implemented as one or more dedicated hardware components, such as application-specific integrated circuits (ASICs) and/or field programmable gate arrays (FPGAs).

The server 260 includes at least one or more of the following standard, commercially available, computer components, all interconnected by a bus 635:
1. random access memory (RAM) 626;
2. at least one computer processor 628, and
3. external computer interfaces 630:
   a. universal serial bus (USB) interfaces 630a (at least one of which is connected to one or more user-interface devices, such as a keyboard, a pointing device (e.g., a mouse 632 or touchpad),
   b. a network interface connector (NIC) 630b which connects the computer system 600 to a data communications network, such as the wireless communications network 250; and
   c. a display adapter 630c, which is connected to a display device 634 such as a liquid-crystal display (LCD) panel device.

The server 260 includes a plurality of standard software modules, including:
1. an operating system (OS) 636 (e.g., Linux or Microsoft Windows);
2. web server software 638 (e.g., Apache, available at http://www.apache.org);
3. scripting language modules 640 (e.g., personal home page or PHP, available at http://www.php.net, or Microsoft ASP); and
4. structured query language (SQL) modules 642 (e.g., MySQL, available from http://www.mysql.com), which allow data to be stored in and retrieved/accessed from an SQL database 616.

Together, the web server 638, scripting language 640, and SQL modules 642 provide the server 260 with the general ability to allow the other components of the system 200 to communicate with the server 260 and in particular to provide data to and receive data from the database 616. It will be understood by those skilled in the art that the specific functionality provided by the server 260 to such users is provided by scripts accessible by the web server 638, including the one or more software modules 622 implementing the processes performed by the server 260, and also any other scripts and supporting data 644, including markup language (e.g., HTML, XML) scripts, PHP (or ASP), and/or CGI scripts, image files, style sheets, and the like.

The boundaries between the modules and components in the software modules 622 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the server 260 may be executed by a module (of software modules 622) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 260 normally processes information according to a program (a list of internally stored instructions such as a particular application program and/or an operating system) and produces resultant output information via input/output (I/O) devices 630. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

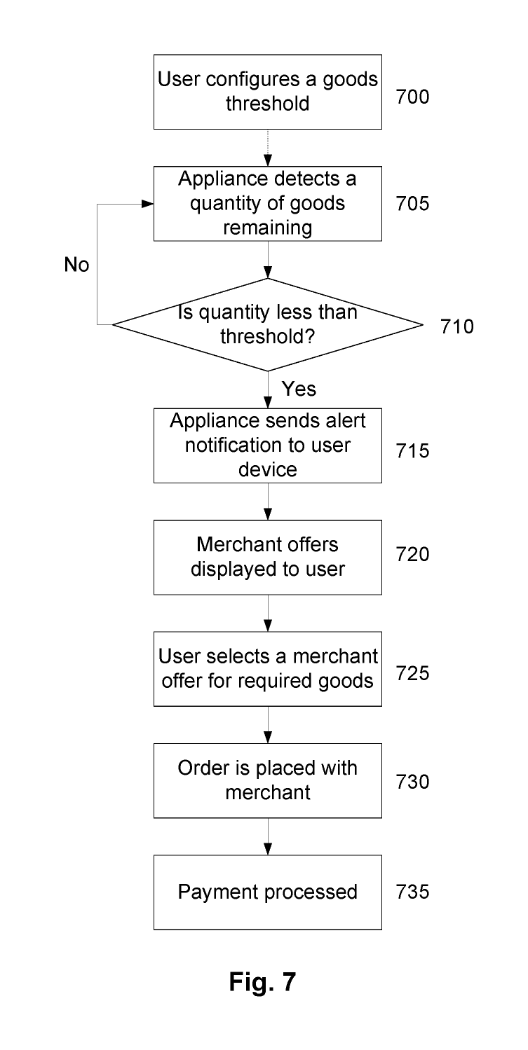

An example process of purchasing goods for an appliance through an application executing on the user device will now be described in more detail with reference to FIG. 7.

In this example, at step 700 a user configures a goods threshold which is typically indicative of a minimum or lower limit of a particular goods item. The goods threshold represents a limit that when reached will trigger the appliance to send an alert notification to the user that the replacement goods needs purchasing. Typically, the user configured goods threshold is sent from the user device 230 to the network connected appliance 220.

At step 705, the appliance 220 detects a quantity or amount of goods remaining using a suitable sensor such a load cell, proximity sensor or camera as previously described. At step 710, the processor of the appliance 220 processes the sensor data and determines whether the quantity of goods remaining is less than the threshold. If not, the process returns to step 705 and the quantity of goods remaining continues to be monitored. If the quantity or amount of goods remaining or available is less than the user defined threshold the appliance 220 generates an alert notification and sends this to the user device 230 at step 810. The alert notification will typically display the status information including a list of required goods to the user at step 815.

At step 720, one or more merchant offers are displayed to the user in accordance with the required goods listed in the alert notification. The merchant offers may be retrieved by the application from the merchant server 260 or database. At step 725, the user selects a preferred merchant offer and places an order for the goods at step 730. Finally, at step 735 payment for the goods is processed with the merchant via the payment system 240. The payment may be processed through a digital wallet integrated with the application or via a user account otherwise linked to the application or via the user manually entering account details at checkout.

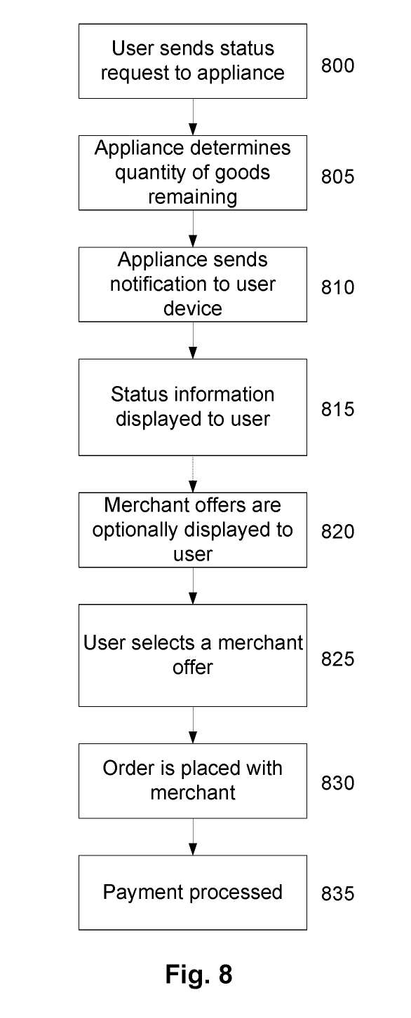

A further example process of purchasing goods for an appliance through an application executing on the user device will now be described in more detail with reference to FIG. 8.

In this example, at step 800 the user sends a request for status information to the appliance 220. The user may request the status of all goods or alternatively may request the status of a particular item of goods.

At step 805, the appliance 220 detects a quantity or amount of goods remaining in accordance with the user request using the sensors as previously described. At step 810, the processor of the appliance 220 processes the sensor data and generates a notification and sends this to the user device 230. The status information is displayed to the user at step 815 typically in the form of a list of goods and their amount or quantity remaining.

At step 820, one or more merchant offers may optionally be displayed to the user in accordance with the goods listed in the alert notification, regardless of if they are required or not as defined by the user configured goods threshold. The merchant offers may be retrieved by the application from the merchant server 260 or database. At step 825, the user selects a preferred merchant offer and places an order for the goods at step 830. Finally, at step 835 payment for the goods is processed with the merchant via the payment system 240 as previously described.

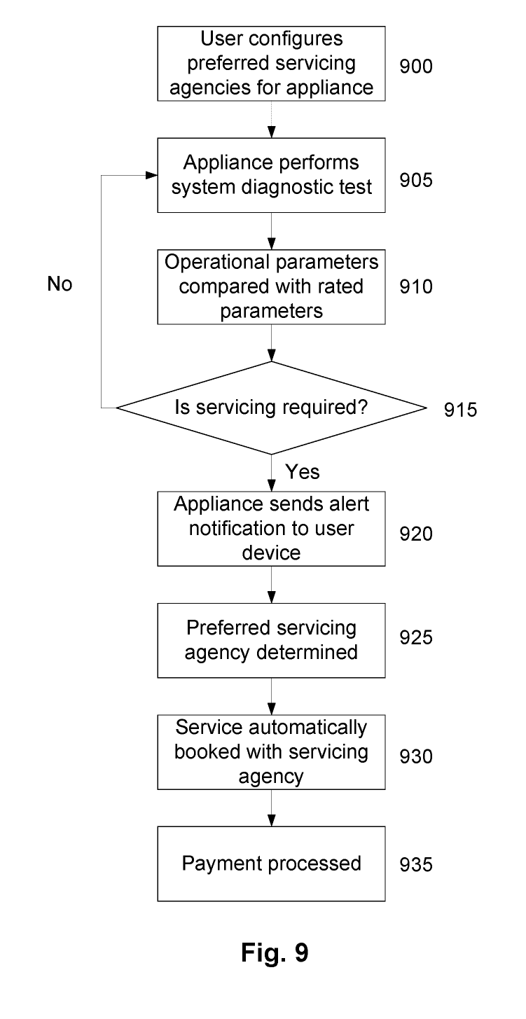

An example of a process of booking a service for the appliance with a preferred servicing agency shall now be described with reference to FIG. 9.

In this example, at step 900 the user configures preferred servicing agencies for each appliance, for example a manufacturer or licensed repair company. At step 905, the appliance 220 performs a system diagnostic test. This will typically involve various sensors monitoring particular operational parameters of the appliance such as voltage, current draw, temperature, motor speed, drain and pump performance etc. depending on the particular appliance. At step 910, the appliance compares the sensed operational parameters with the rated performance parameters and at step 915, the appliance determines whether servicing is required, for example if the operational parameters do not meet expected targets. In other situations, a component of the appliance may malfunction and this would also trigger a requirement for servicing. If no servicing is required, the process returns to the diagnostic step 905.

At step 920, if servicing is required, the appliance 220 generates an alert notification which is sent to the user device 230. The application is then responsive at step 925 to determine the preferred servicing agency for the appliance or particular fault detected or service required and at step 930 proceeds to automatically book the service with the servicing agency. At step 935, the payment for the service is processed with the servicing agency via the payment system 240 for example by automatically debiting the user's account, the details of which may be retrieved from a digital wallet or the like linked to the application.

Whilst the previous examples have focussed on the use of the platform to manage home appliances, it is to be appreciated that other appliances may also be managed and one example is an automobile. The status of various parameters such as gas or fuel level, battery life remaining, air pressure in tyres etc. may be monitored and reported to the user device via an alert notification when they reach a user defined lower limit. The user may then be provided with an option to pre-pay for the purchase of an amount of fuel or the like from a gas station so that the user can simply fill up and leave without having to enter the station to pay.

Accordingly, it will be appreciated that the above described system in at least example provides a single platform for users to remotely (on-the-go) manage all of their home appliances in terms of supply of consumable goods and servicing. This level of management ability may further be integrated with remote control of the appliances as well. The ability to manage the supply of goods and servicing of the appliances has time saving and efficiency benefits as goods may be ordered before they run out to ensure that supply is maintained at usable levels. Goods can be purchased from anywhere that there is mobile connectivity and in the case of automobiles, fuel may be pre-purchased prior to arriving at the gas station. Also, the ability to pre-emptively book servicing will ensure that down-time of appliances is minimised and that they are operating at rated performance levels of efficiency. The platform also provides benefits for merchants who can make offers available to users of the platform and advertise their goods.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) A system for managing one or more network connected appliances, the system including one or more electronic processing devices that:
a) receive an alert notification generated by the one or more appliances, the alert notification including status information indicative of at least one of:
i) a determined service condition of an appliance; and,
ii) a determined quantity of available goods associated with the appliance;
b) determine a goods/service requirement for the appliance in accordance with the status information;
c) generate a representation of the goods/service requirement;
d) cause the representation of the goods/service requirement to be displayed to a user on a user device;
e) determine one or more merchant offers in accordance with the required goods/service;
f) cause the one or more merchant offers to be displayed to the user; and,
g) in response to user input:
i) determine a user selected merchant offer;
ii) cause an order to be placed with the selected merchant for the required goods/service; and,
iii) cause payment for the required goods/service to be processed with the selected merchant via a payment system.

2) The system according to claim 1, wherein the alert notification is generated using one or more sensors.

3) The system according to claim 1, wherein data indicating the status information is transmitted to the user device via a communications network.

4) The system according to claim 3, wherein the communications network uses a wireless communication protocol including one of Bluetooth™ Low Energy (BLE), ZigBee, WiFi or NFC.

5) The system according to claim 3, wherein the status information is transmitted to the user device at least one of:
a) periodically;
b) in response to a user request;
c) in response to the determined service condition; and,
d) in response to the determined quantity of available goods.

6) The system according to claim 1, wherein the alert notification is generated by the appliance and sent to the user device if one of:
a) the determined quantity of available goods is below a user configured lower limit of available goods remaining; and,
b) the determined service condition is indicative of one of:
i) an appliance malfunction; and,
ii) a component of the appliance being below a performance threshold.

7) The system according to claim 1, the system further including one or more electronic processing devices that:
a) generate a notification that an order for the required goods/service has been placed; and,
b) cause the notification to be sent to a user device of one or more further users of the appliance.

8) The system according to claim 1, wherein the one or more electronic processing devices form part of the user device, the user device executing an application that receives the status information from the appliance and initiates a payment process with the merchant via the payment system.

9) A method for managing one or more network connected appliances, the method including, in one or more electronic processing devices:
a) receiving an alert notification generated by the one or more appliances, the alert notification including status information indicative of at least one of:
i) a determined service condition of an appliance; and,
ii) a determined quantity of available goods associated with the appliance;
b) determining a goods/service requirement for the appliance in accordance with the status information;
c) generating a representation of the goods/service requirement;
d) causing the representation of the goods/service requirement to be displayed to a user on a user device;
e) determining one or more merchant offers in accordance with the required goods/service;
f) causing the one or more merchant offers to be displayed to the user; and,
g) in response to user input:
iv) determining a user selected merchant offer;
v) causing an order to be placed with the selected merchant for the required goods/service; and,
vi) causing payment for the required goods/service to be processed with the selected merchant via a payment system.

10) The method according to claim 9, wherein the alert notification is generated using one or more sensors.

11) The method according to claim 9, wherein data indicating the status information is transmitted to the user device via a communications network.

12) The method according to claim 11, wherein the communications network uses a wireless communication protocol including one of Bluetooth™ Low Energy (BLE), ZigBee, WiFi or NFC.

13) The method according to claim 11, wherein the status information is transmitted to the user device at least one of:
a) periodically;
b) in response to a user request;
c) in response to the determined service condition; and,
d) in response to the determined quantity of available goods.

14) The method according to claim 9, wherein the alert notification is generated by the appliance and sent to the user device if one of:
a) the determined quantity of available goods is below a user configured lower limit of available goods remaining; and,
b) the determined service condition is indicative of one of:
i) an appliance malfunction; and,
ii) a component of the appliance being below a performance threshold.

15) The method according to claim 9, the method further including, in one or more electronic processing devices:
a) generating a notification that an order for the required goods/service has been placed; and,
b) causing the notification to be sent to a user device of one or more further users of the appliance.
